(19) United States
(12) Patent Application Publication
(10) Pub. No.: US 2023/0210108 A1
(43) Pub. Date: Jul. 6, 2023

(54) ANTIMICROBIAL COATING FOR POLYMERIC FOOD PACKAGING

(71) Applicant: VACOPAK INDUSTRIES LTD., Yehud-Monosson (IL)

(72) Inventors: Ana DOTAN, Ramat Gan (IL); Yael ROTH, Tel Aviv (IL); Amos OPHIR, Zikhron Ya'aqov (IL); Shay SHAMA, Yehud (IL)

(21) Appl. No.: 17/927,092

(22) PCT Filed: May 26, 2021
(86) PCT No.: PCT/IL2021/050621

§ 371 Date: Nov. 22, 2022

Related U.S. Application Data
(60) Provisional application No. 63/030,567, filed on May 27, 2020.
(60) Provisional application No. 63/030,583, filed on May 27, 2020.

(51) Int. Cl. A01N 25/10; A01N 37/02; A01N 43/08; A01N 59/16; A01P 1/00

(52) U.S. Cl. CPC A01N 25/10; A01N 37/02; A01N 43/08; A01N 59/16; A01P 1/00

(57) ABSTRACT

Provided herein are antimicrobial coating compositions and food packaging materials coated therewith. The coating compositions include at least one antimicrobial active agent and a hydrophilic polymer, such that the active agent is immobilized within the composition.

### FIELD OF THE INVENTION

Provided herein are antimicrobial coating compositions and food packaging materials coated therewith. The coating compositions include at least one antimicrobial active agent and a hydrophilic polymer, such that the active agent is immobilized within the composition.

### BACKGROUND

Shelf-life extension of food products is a fundamental ongoing need of the food industry. A large amount of food products is wasted since it goes off before being consumed.

Furthermore, outbreaks of new and possibly lethal viral-induced diseases, are of main concern worldwide, where the food industry often plays a critical role in spreading diseases.

PCT Publication No. WO 01/49121 discloses a sheet material substrate such as plastic film having beneficial substance attached thereto, the beneficial substrate includes, antimicrobial agent and antioxidants among others, wherein the attachment may be achieved by a bonding agent, for example, acrylic lacquer.

Esposti et al. (Food microbiology, 76:173-179, 2018) discloses the effect of a coating, which includes nisin, enterocin 416K1 and living bacteriocin-producer Enterococcus casseliflavus IM 416K1 entrapped in polyvinyl alcohol (PVOH) and applied to poly ethylene terephthalate (PET) films, on the growth of Listeria monocytogenes ATCC 19117, finding that live-Enterococcus-doped film is most effective and can behave as a smart active food packaging.

There is an unmet need for adding shelf life to packaged food, while maintaining the visibility, aroma and taste thereof. In addition, there is a need for reducing, or preventing, the spread of diseases through contacting food packaging.

### SUMMARY

There is provided, in accordance with some embodiments, a food packaging material having inner and outer surfaces, wherein at least one surface is coated with an antimicrobial coating composition, which includes a hydrophilic polymer (or a mixture of polymers) and antimicrobial active agent(s) immobilized within the coating composition. The coating composition may be applied on the inner surface and/or on the outer surface of the food packaging material. In accordance with some embodiments, a food package having the antimicrobial coating applied on the inner surface thereof is exerting antimicrobial activity only upon contacting the food product(s) enclosed in the package. In accordance with additional or alternative embodiments, a food package having the antimicrobial coating applied on the outer surface thereof is exerting antimicrobial activity when contacting (holding) the food package, namely, when the skin of the holder is in contact with the coated food package.

Advantageously, a food package having its outer surface coated by the antimicrobial coating is capable of preventing the spread of diseases, in particular, diseases that are prone to being distributed by contacting infected surfaces. This ability is particularly essential during the outbreak of viral strains that lead to pandemics, such as, SARS-CoV, also known as SARS which erupted during the years 2002 and 2003; and SARS-CoV-2, also known as COVID-19, erupted late 2019.

Another benefit conferred by the coating composition disclosed herein is that a food packaging having its inner surface coated with the coating composition disclosed herein is capable of extending shelf life of food products contained therein, or enclosed thereby, while maintaining their freshness, taste and visibility.

The coating composition including the active agent may be applied on any commercial food packaging material, while performing its antimicrobial activity only upon contacting the surface of a food product packed thereby or upon contacting the skin of a subject holding the food packaging material. Moreover, the active agent does not evaporate within the packaging, but rather remains fixed to the packaging material and hence does not change the smell or taste of the food packed within packaging made of the coated rigid material.

Surprisingly, as exemplified herein, the coating of the polymeric food packaging disclosed herein is thermo-stable. Accordingly, the antibacterial activity exerted by the polymeric food packaging is not impaired nor attenuated following thermoforming processing.

There is provided, in accordance with some embodiments, a food packaging material comprising an outer surface and an inner surface, the inner surface is configured to face food product enclosed by the food packaging material, and a coating composition comprising at least one antimicrobial active agent and a hydrophilic polymer comprising less than 50% acrylates, wherein said at least one antimicrobial active agent is immobilized within the coating composition, and wherein the coating composition is configured to coat at least one of said inner and outer surfaces.

According to some embodiments, the at least one antimicrobial agent is selected from the group consisting of: essential oils, acids, esters or salts thereof and bacteriocins.

According to some embodiments, the at least one antimicrobial agent is selected from the group consisting of: benzoic acid salt, salicylic acid salt, ascorbic acid, zinc oxide and lauric alginate.

According to some embodiments, said coating composition is coating said inner surface.

According to some embodiments, said coating composition is coating said outer surface. According to some embodiments, said coating composition is coating said outer and said inner surfaces. According to some embodiments, said coating composition is forming a film coating said inner and/or outer surfaces.

According to some embodiments, said food product comprises fresh food product. According to some embodiments, the fresh food product comprises any one or more of fluid, semi-fluid and solid food product.

According to some embodiments, said coating composition is configured to perform antimicrobial activity only upon contacting a surface of the fresh food product.

According to some embodiments, the food packaging material is opaque.

According to some embodiments, the food packaging material comprises a rigid scaffold comprising the outer surface and the inner surface, wherein at least one of said inner and outer surfaces is coated with the hydrophilic polymer comprising less than 50% acrylates, and said coated surface is further coated with said coating composition.

According to some embodiments, the food packaging material is a polymeric packaging material.

According to some embodiments, said hydrophilic polymer is selected from non-acrylate polymers, non-acrylate co-polymers and co-polymers comprising less than 50% acrylates.

According to some embodiments, said hydrophilic polymer is selected from the group consisting of: urethanes, urethane-acrylates where the contents of acrylate is less than 50%, ethylene-vinyl-acetates, alginate, polyvinyl alcohol, acrylic-ester polymers, whey-protein polymers, Zein-protein polymers, Chitosan polymers and polysaccharides.

According to some embodiments, the hydrophilic polymer is formed of a food grade polymer.

According to some embodiments, the rigid scaffold comprises any one or more of wood, paper and paperboard-based material.

According to some embodiments, the food packaging material is a polymeric food packaging.

According to some embodiments, the food packaging is transparent.

According to some embodiments, there is provided a container configured to contain the food product therewithin formed from the food packaging material disclosed herein.

According to some embodiments, the container is configured to enclose the food product under vacuum.

According to some embodiments, the container is configured to enclose therewithin fluids.

According to some embodiments, there is provided a coating composition for food packaging, the coating composition comprising at least one antimicrobial active agent and a hydrophilic polymer comprising less than 50% acrylates, wherein said at least one active agent is immobilized within the coating composition.

According to some embodiments, the coating composition is configured to exert antimicrobial activity only upon contacting a humid surface of food product or a skin of a subj ect.

According to some embodiments, a method for coating a surface of a food packaging material, the method comprising:
providing a food packaging material comprising an inner surface and an outer surface;
applying to at least one surface of the food packaging material a hydrophilic thermoplastic polymer emulsion comprising at least one antimicrobial active agent, wherein the hydrophilic thermoplastic polymer comprises less than 50% acrylates; and
dry-curing the applied polymer emulsion, thereby coating said at least one surface such that the at least one active agent is immobilized within the coating.

Other objects, features and advantages of the present invention will become clear from the following description, examples and drawings.

Certain embodiments of the present disclosure may include some, all, or none of the above advantages. One or more other technical advantages may be readily apparent to those skilled in the art from the figures, descriptions, and claims included herein. Moreover, while specific advantages have been enumerated above, various embodiments may include all, some, or none of the enumerated advantages.

### BRIEF DESCRIPTION OF THE DRAWINGS

Some embodiments of the disclosure are described herein with reference to the accompanying figures. The description, together with the figures, makes apparent to a person having ordinary skill in the art how some embodiments may be practiced. The figures are for the purpose of illustrative description and no attempt is made to show structural details of an embodiment in more detail than is necessary for a fundamental understanding of the disclosure. For the sake of clarity, some objects depicted in the figures are not to scale.

In the Figures:

FIG. 1 schematically depicts a food packaging, as known in the art.

FIG. 2 schematically depicts the food packaging, according to some embodiments.

FIGS. 3A and 3B schematically depict the food packaging made of a rigid material (3A) and a cross-section thereof (3B), according to some embodiments.

FIG. 4 shows the coating instruments used, according to some embodiments.

FIGS. 5A and 5B present the activity of the coating against Gram-negative and Gram-positive bacteria, respectively.

FIG. 6 presents antiviral and antibacterial activity of the antimicrobial coatings, according to some embodiments.

FIGS. 7A and 7B present the activity of the coated products following thermoforming against Gram-negative and Gram-positive bacteria, respectively.

FIG. 8 presents antimicrobial activity of paperboard coated with antimicrobial formulations.

### DETAILED DESCRIPTION

In the following description, various aspects of the disclosure will be described. For the purpose of explanation, specific configurations and details are set forth in order to provide a thorough understanding of the different aspects of the disclosure. However, it will also be apparent to one skilled in the art that the disclosure may be practiced without specific details being presented herein. Furthermore, well-known features may be omitted or simplified in order not to obscure the disclosure. In the figures, like reference numerals refer to like parts.

Throughout the figures of the drawings, different superscripts for the same reference numerals may be used to denote different embodiments of the same elements. Embodiments of the disclosed devices and systems may include any combination of different embodiments of the same elements. Specifically, any reference to an element without a superscript may refer to any alternative embodiment of the same element denoted with a superscript. Components having the same reference number followed by different lowercase letters may be collectively referred to by the reference number alone. If a particular set of components is being discussed, a reference number without a following lowercase letter may be used to refer to the corresponding component in the set being discussed. In order to avoid undue clutter from having too many reference numbers and lead lines on a particular drawing, some components will be introduced via one or more drawings and not explicitly identified in every subsequent drawing that contains that component.

There is provided, in accordance with some embodiments, a food packaging material comprising an outer surface and an inner surface, the inner surface is configured to face food product enclosed by the food packaging material, and a coating composition comprising at least one antimicrobial active agent and a hydrophilic polymer comprising less than 50% acrylates, wherein said at least one antimicrobial active agent is immobilized within the coating composition, and wherein the coating composition is configured to coat at least one of said inner and outer surfaces.

The term “hydrophilic polymer” as used herein is intended to cover charged, polar, polymers and further intended to include waterborne polymers. In some embodiments, the hydrophilic polymer is a thermoplastic polymer.

The term “immobilized” as used herein is exchangeable with the term non-volatile and is intended to define that the at least one active agent is not volatile and does not evaporate, rather it remains within the coating composition. In some embodiments, the at least one active agent is in solid phase (e.g. powder) and is embedded within the hydrophilic polymer and hence remains immobilized thereto. In some embodiments, the at least one active agent is of high molecular weight and low volatility. While being non-volatile and immobilized, the at least one active agent maintains its potential antimicrobial activity, and exerts it only upon contacting a food product or the skin of a subject holding the packaging. It is to be understood, that the bonding between the antimicrobial agent(s) and the matrix (e.g. polymer) are physiological bonding and not chemical bonding. Hence, the antimicrobial agent(s) maintain their antimicrobial activity, when embedded within the matrix.

The term antimicrobial as used herein includes and/or is interchangeable with any one of the terms “antiviral”, “antibacterial” and “antifungal”.

In some embodiments, the at least one active agent comprises a plurality of different antimicrobial agents. In some embodiments, each of the plurality of active agents is configured to exert a different antimicrobial activity relative to other active agents in the plurality of active agents. For example, the plurality of active agent may include at least one antiviral agent, at least one antifungal agent and at least one antiviral agent.

In some embodiments, the coating composition is in a fluid form, or in the form of emulsion, or in the form of dispersion, and hence can be easily spread or sprayed onto any one of the surfaces of the substrate (polymeric package material).

According to some embodiments, the at least one antimicrobial active agent is a natural active agent, obtained from a natural source, and not an artificially synthesized molecule. According to some embodiments, the at least one active agent is selected from the group consisting of: essential oils, acids and bacteriocins. Each possibility is a separate embodiment of the present invention.

According to some embodiments, the at least one active agent comprises at least one essential oil selected from the group consisting of agar oil or oodh, distilled from agarwood (Aquilaria malaccensis), Ajwain oil, distilled from the leaves of (Carum copticum), Angelica root oil, distilled from the Angelica archangelica, Anise oil, from the Pimpinella anisum, Asafoetida oil, Balsam of Peru, from the Myroxylon, Basil oil, Bay oil, Bergamot oil, Black pepper oil, Buchu oil, made from the buchu shrub, Birch oil, Camphor oil, Cannabis flower essential oil, Calamodin oil (or calamansi essential oil), Caraway seed oil, Cardamom seed oil, Carrot seed oil, Carvacrol oil, Cedar oil (or cedarwood oil), Chamomile oil, Calamus oil, Cinnamon oil, Cistus ladanifer oil (leaves and flowers), Citron oil, Citronella oil, Citrus oil, Clary Sage oil, Coconut oil, Clove oil, coffee oil, Coriander oil, Costmary oil (bible leaf oil), Costus root oil, Cranberry seed oil, Cubeb oil, Cumin seed oil/black seed oil, Cypress oil, Cypriol oil, Curry leaf oil, Davana oil, from the Artemisia pallens, Dill oil, Elecampane oil, Eucalyptus oil, Fennel seed oil, Fenugreek oil, Frankincense oil, Galangal oil, Galbanum oil, Garlic oil distilled from Allium sativum, Geranium oil, Ginger oil, Goldenrod oil, Grapefruit oil, Henna oil, Helichrysum oil, Hickory nut oil, Horseradish oil, Hyssop, Idaho-grown Tansy, Jasmine oil, Juniper berry oil, Laurus nobilis oil, Lavender oil, Ledum oil, Lemon oil, Lemongrass oil, Lime, Litsea cubeba oil, Linalool, extract of liquorice root, Mandarin oil, Marjoram oil, Melissa oil, Mentha arvensis oil, Moringa oil, Mountain Savory oil, Mugwort oil, Mustard oil, Myrrh oil, Myrtle, Neem oil, Neroli produced from the blossom of the bitter orange tree, Nutmeg oil, Orange oil, Oregano oil, Orris oil extracted from the roots of the Florentine iris (Iris florentina), Iris germanica and Iris pallida, Palo Santo, Palmarosa Essential oil, Parsley oil, Patchouli oil, Perilla essential oil, Pennyroyal oil, Peppermint oil, Petitgrain, Pine oil, Ravensara, Red Cedar, Roman Chamomile, Rose oil, Rosehip oil, Rosemary oil, Rosewood oil, Sage oil, Sandalwood oil, Sassafras oil, Savory oil, from Satureja species, Schisandra oil, Spearmint oil, Spikenard, Spruce oil, Star anise oil, Tangerine, Tarragon oil, distilled from Artemisia dracunculus, Tea tree oil, Thyme oil, Tsuga oil, Turmeric, Valerian oil, Warionia, Vetiver oil (khus oil), Western red cedar, Wintergreen, Yarrow oil and Ylang-ylang oil. Each possibility is a separate embodiment of the present invention.

In some embodiments, the one or more essential oil is selected from the group consisting of Lemmon essential oil, Clove oil, Citrus oil, Carvacrol essential oil. Each possibility is a separate embodiment of the present invention.

In some embodiments, the at least one active agent is an acid. In some embodiments, the acid is selected from organic acid, fatty acid and amino acid. Each possibility is a separate embodiment of the present invention. In some embodiments, the acid comprises acid esters.

Organic acids have antimicrobial properties presumably based on their ability to cross cellular membrane, due to the lipophilic nature of their undissociated form, modifying the proton and associated anion concentrations in the cytoplasm. As a result, purine bases and essential enzymes are negatively affected, thus bacterial viability decreases. Organic acids are generally available as calcium, potassium or sodium salts to decrease odor and volatility and facilitate the manufacturing processes.

In some embodiments, the acid, ester or a salt thereof is selected from the group consisting of formic acid, coconut fatty acid, phenyllactic acid, propionic acid, sodium butyrate, sodium heptanoate, acetic acid, lactic acid, citric acid, pelargonic acid, benzoic acid, ascorbic acid sorbic acid, sodium salt of coconut fatty acid distillates, sucrose esters of fatty acids, lauric acid, palmitoleic acid, monocaprin, linoleic acid, gallic acid, medium-chain fatty acid, palmitic acid, polyunsaturated fatty acids and tartaric acid. Each possibility is a separate embodiment of the present invention.

In preferred embodiments, the salt of a corresponding acid was used as the antimicrobial agent.

In some embodiments, the at least one antimicrobial active agent comprises a salt of ascorbic acid.

In some embodiments, the at least one antimicrobial active agent comprises lauryl alginate (also termed lauric alginate).

In some embodiments, the at least one active agent is a bacteriocin. In some embodiments, the at least one active agent is selected form the group consisting of nisin bacteriocin, natamycin bacteriocin, aureocin A53, aureocin A70, lysostaphin, sublancin, glycocin F and methyl cinnamate Each possibility is a separate embodiment of the present invention.

In some embodiments, the coating composition is coating the inner surface. In some embodiments, the coating composition is coating the outer surface. In some embodiments, the composition is coating the inner and/or outer surfaces. In some embodiments, the coating composition includes the at least one active agent is coating the inner and outer surfaces.

Coating may be performed by any method known in the art, including, but not limited to, extrusion/blending, casting, coating for example, through dispersion of the at least one active agent, continuous in-line spray coating and/or wet-roll coating.

In some embodiments, the coating composition includes is forming a film which is coating the inner and/or outer surfaces. In some embodiments, the film thickness is typically in the range 1 to 100 µm, 1 to 90 µm, 1 to 80 µm, 1 to 70 µm, 1 to 60 µm, 1 to 50 µm, 1 to 40 µm, 1 to 30 µm, 1 to 20 µm, 1 to 10 µm, 1 to 7 µm, 1 to 5 µm. Each possibility is a separate embodiment of the present invention.

In some embodiments, the food product comprises fresh food product. The fresh food product may include any one or more of fluids and solid food products. In some embodiments, the food product is a fluid food product. In some embodiments, the fluid food product comprises any one or more of water, milk, milk drinks, such as, coffee and cocoa milk, soup, oil, vinegar, soft drinks, shakes, smoothies and beverages.

In some embodiments, the food product is a solid food product. In some embodiments, the solid food product comprises any one or more of fruit, vegetable, milk products, such as, yogurt, cream, butter, cheese, custard and ice cream, ready-made food, frozen food product, baby formulae (powder), bakery products, such as, white flour, whole-meal flower, baking powder, rice flour and corn flour, sugar and sugar-based products, such as, condensed sugar and powder (confectioners) sugar, coffee beans and products derived therefrom including confectionary, cocoa powder, tea bags and tea leaves. In some embodiments, the food product comprises post harvested fruits and vegetables. In some embodiments, the food comprises grains, cereals, and legumes.

In some embodiments, the coating composition is configured to perform antimicrobial activity upon contacting the fresh food product or the skin of a subject in contact with the coating composition. At the region of contact between the coating composition, which includes the at least one active agent and the food productor the skin, the at least one active agent exerts its antimicrobial activity. In some embodiments, the contact is an intimate contact. In some embodiments, the contact area is slightly humid due to water molecules contained within the food product, or on the surface of the food product or on the skin of the subject. In some embodiments, the at least one antimicrobial agent is activated upon contacting a thin film of fluids (e.g., water) on the surface of the food product.

In some embodiments, the food packaging is a polymeric food packaging. In some embodiments, the polymeric food packaging is transparent, enabling to see there through the food wrapped thereby or enclosed therewithin.

In some embodiments, the food packaging is opaque.

In some embodiments, the hydrophilic polymer is a waterborne thermoplastic polymer. In some embodiments, the composition of the hydrophilic polymer and the at least one active agent is in the form of emulsion. In some embodiments, the hydrophilic polymer is selected from non-acrylate polymers, non-acrylate co-polymers and co-polymers, which includes less than 50% acrylates. Each possibility is a separate embodiment of the present invention.

It is to be understood that the hydrophilic polymer is not a thermoset polymer.

In some embodiments, the antimicrobial coating composition is devoid of thermoset polymers. In some embodiments, the coating composition is devoid of heavy metals. In some embodiments, the coating composition is devoid of Ag ions.

In some embodiments, the hydrophilic polymer is selected from the group consisting of: urethanes, urethane-acrylates where the contents of acrylate is less than 50%, ethylene-acrylate copolymer where the contents of acrylate is less than 50%, ethylene-methylacrylate (EMA) copolymer where the contents of acrylate is less than 50%, ethylene-vinyl-acetates (EVA), polyvinyl alcohol (PVA, PVOH), acrylic-ester polymers, whey-protein polymers, alginate polymers, Zein-protein polymers, Chitosan polymers and polysaccharides. Each possibility is a separate embodiment of the present invention.

In some embodiments, the hydrophilic polymer comprises is less than 45% acrylates. In some embodiments, the hydrophilic polymer comprises is less than 45% acrylates. In some embodiments, the hydrophilic polymer comprises is less than 40% acrylates. In some embodiments, the hydrophilic polymer comprises is less than 30% acrylates. In some embodiments, the hydrophilic polymer comprises is less than 25% acrylates. In some embodiments, the hydrophilic polymer comprises is less than 20% acrylates. In some embodiments, the hydrophilic polymer comprises is less than 15% acrylates. In some embodiments, the hydrophilic polymer comprises is less than 10% acrylates. In some embodiments, the hydrophilic polymer comprises is less than 5% acrylates.

In some embodiments, the hydrophilic polymer is devoid of acrylates.

In some embodiments, the hydrophilic polymer is made of food grade polymer, such as, plastic e.g., polyethylene and its varieties, such as, polyethylene terephthalate (PET), high density polyethylene (HDPE) and low-density polyethylene (LDPE), polyesters, polypropylene, Polystyrene (PS) and polyvinyl chloride (PVC) among others.

In some embodiments, the coating composition comprises a hydrophobic polymer selected from urethan acrylate, polyvinyl acetate, alginate or blends thereof and a t least one antimicrobial agent selected form lauric alginate and ascorbic acid.

In some embodiments, the food packaging material is a food grade packaging material. In some embodiments, the food packaging material includes at least one of paper, paper-based material, bioresins, wood, bamboo, vegetable parchment, glass and poly-methyl methacrylate (Perspex®).

In some embodiments, the food packaging is a polymeric food packaging. In some embodiments, the polymeric food packaging is in the form of a container. In some embodiments, the container further includes a flexible cover configured to close the container when food products are contained therein, wherein the cover includes a cover inner surface configured to face the contents of the container, and a cover outer surface configure to face the environment outside the packaging, and wherein the coating composition further covers the inner and/or outer surface.

In some embodiments, the polymeric food packaging may be elastic.

In some embodiments, the polymeric food packaging is transparent, enabling to see there through the food wrapped thereby or enclosed therewithin.

In some embodiments, the food product may be wrapped by the elastic polymeric food packaging and may optionally be supported by a solid tray. The solid tray may be formed from any food grade solid substrate, such as, plastic, cellulose acetate, paper, bioresins, wood and bamboo.

In some embodiments, the food packaging material comprises a rigid scaffold comprising the outer surface and the inner surface, wherein at least one of said inner and outer surfaces is coated with said coating composition.

In some embodiments, the at least one of said inner and outer surfaces is coated with the hydrophilic polymer comprising less than 50% acrylates, and said coated surface is further coated with said coating composition.

The term “rigid” as used herein refer to a solid material, rather than a soft material. The solid material may have some level of flexibility, such as, the flexibility of cardboard or perpex™. However, it is rigid enough to form a container, a crate, a tray and the like.

In some embodiments, the paper-based material may include any one or more of paper, paperboard, cardboard, laminated paper, laminated cardboard, laminated paperboard, glassine paper, waxed paper, recycled paper, kraft paper, greaseproof paper, corrugated board, and liquid packaging board (e.g., made of a multi-ply structure of paper, polyethylene, and aluminum foil). Each possibility is a separate embodiment of the present invention.

In some embodiments, there is provided a container configured to contain a food product, the container is made from the rigid food packaging material disclosed herein, coated with the coating composition. In some embodiments, the container/box is coated the hydrophilic polymer, and on top of said coating, it is further coated with the coating composition.

The term “container” as used herein is exchangeable with any receptacle, vessel or box suitable for food packaging. In the context of the present disclosure, the container is a coated container, namely, it is coated with the antimicrobial coating composition disclosed herein, directly, or it is coated with an initial polymeric sealing film configured to seal at least the inner surface of the container and on top of said initial polymeric sealing film it is further coated with the antimicrobial coating composition. The polymeric sealing film may be any polymer known in the art. In some embodiments, the polymeric sealing film contains ethylene-vinyl acetate (EVA). In some embodiments, the polymeric sealing film comprises EVA. In some embodiments, the polymeric sealing film has a thickness of 0.5 to 10 µm, 0.75 to 7 µm, or 1 to 5 µm. Each possibility is a separate embodiment of the present invention. In some embodiments, the polymeric sealing film is a hydrophilic polymer comprising less than 50% acrylates.

In some embodiments, the coated container is configured to hold liquid food product (such as milk or fruit/vegetable juice). In some embodiments, the container is containing food product under vacuum. In some embodiments, the container is containing a food product and is sealed. In some embodiments, the container is reversibly sealed. In some embodiments, the container may be coated with the antimicrobial coating composition on an inner surface and/or on an outer surface thereof. In some embodiments, the antimicrobial coating composition on the inner surface of the container may prolong the shelf life of the food product. In some embodiments, the antimicrobial coating composition on the inner surface of the container may prolong the shelf life of the food product. In some embodiments, the antimicrobial coating composition on the outer surface of the container may assist in preventing the spread of diseases.

In some embodiments, the container is in the form of a crate. In some embodiments, the container further includes a plugging mechanism, such as, a cork, configured to seal the container, and reopen it.

In some embodiments, there is provided a method for coating a surface of a food packaging material, the method includes:
(a) providing a food packaging material having an inner surface and an outer surface;
(b) applying to at least one of the inner and the outer surfaces of the food packaging material a hydrophilic thermoplastic polymer emulsion, which includes at least one antimicrobial active agent, wherein the hydrophilic thermoplastic polymer comprises less than 50% acrylates; and
(c) dry-curing the applied polymer emulsion, thereby coating the at least one surface such that the at least one active agent is immobilized within the coating.

In some embodiments, the method food packaging comprises a rigid scaffolding, and the method further comprises the step of applying to the at least one of the inner and the outer surfaces of the food packaging material a polymeric sealing film, prior to step (b).

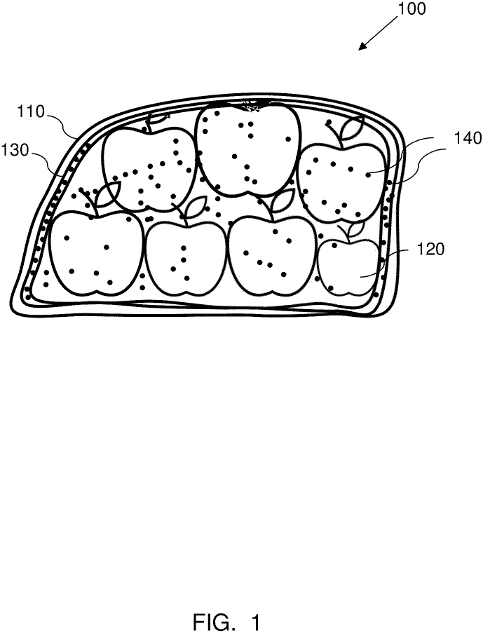

Reference is now made to FIG. 1 which schematically depicts a coated food packaging 100, as known in the art. Food packaging 100, as known in the art, includes a polymeric packaging material 110 having an outer surface and an inner surface facing a food product 120, the inner surface is coated with a polymeric coating film 130, which includes volatile antimicrobial active agents 140. Polymeric coating film 130 is enclosing/wrapping food product 120 (such as an apple, but can be any food product). Volatile antimicrobial active agents 140 are free to evaporate, escape polymeric coating film 130 and penetrate food product 120.

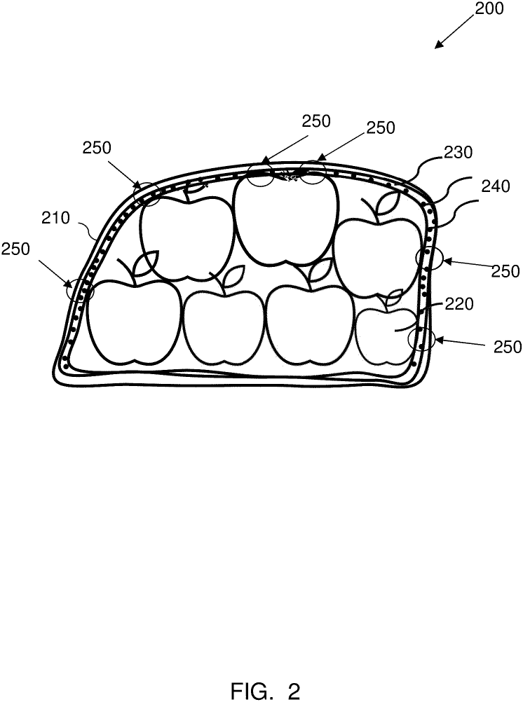

In contrast, reference is now made to FIG. 2 which schematically depicts a coated food packaging 200, according to some embodiments. Food packaging 200 includes a polymeric packaging material 210 having an outer surface and an inner surface facing a food product 220 (e.g., an apple), the inner surface is coated with a polymeric coating film 230, which includes non-volatile antimicrobial active agent 240 and hydrophilic polymer comprising less than 50% acrylates. Polymeric coating film 230 is enclosing/wrapping food product 220 such that it is in intimate contact with (typically via a thin water film that is formed) a plurality of surface areas 250 on food product 220 whereby the antimicrobial activity is facilitated by the contact created between antimicrobial active agent 240 and surface areas 250 on food product 220. Advantageously, since antimicrobial active agent 240 is immobilized within polymeric coating film 230 it cannot evaporate, and hence would not penetrate the food product 220. It is noted that, although not shown in FIG. 2, the polymeric coating film (such as film 230), which includes antimicrobial active agent (such as active agent 240) may be also applied on an outer surface of the food packaging to assist in reducing the spread of diseases.

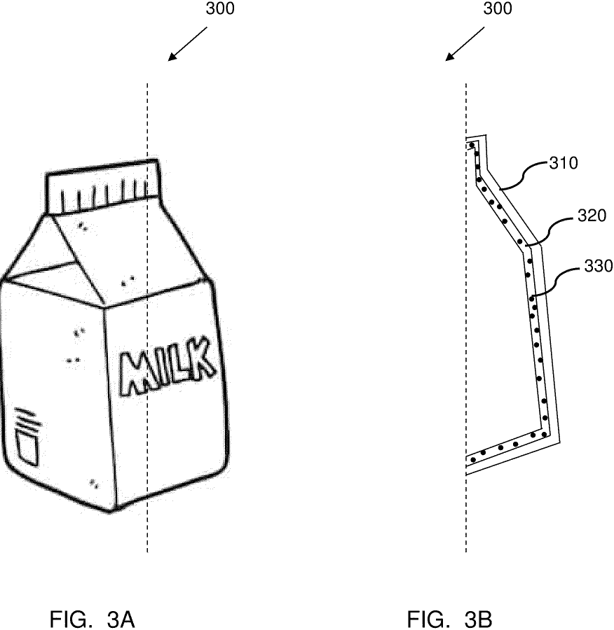

Reference is now made to FIGS. 3A and 3B, which schematically depict a rigid coated food packaging 300 and a cross section thereof, respectively, according to some embodiments. The exemplary food packaging 300 is a milk caron configured to contain milk (but suitable for containing any food product). The cross section exposes rigid scaffolding 310 coated with hydrophilic polymer coating composition 320 (such as a hydrophilic polymer coating composition including less than 50% acrylates, as disclosed herein according to some embodiments), wherein the coating composition includes antimicrobial active agent (e.g., antimicrobial active molecules) 330, immobilized therewithin.

It is noted that, although not shown in FIGS. 3A and 3B, the hydrophilic polymer coating composition (such as coating composition 320), which includes antimicrobial active agent (such as active agent 330) may also be applied on an outer surface of the food packaging to assist in reducing the spread of diseases.

One skilled in the art readily appreciates that the present invention is well adapted to carry out the objects and obtain the ends and advantages mentioned, as well as those inherent therein. The examples provided herein are representative of preferred embodiments, are exemplary, and are not intended as limitations on the scope of the invention.

### EXAMPLES

### Example 1: Coating Surfaces

Air plasma was applied onto each surface for three (3) minutes prior to coating. The surfaces used in the Examples were polyethylene (PET) sheets.

The coating composition was prepared by suspending polymer(s) in water together with the antimicrobial agent(s).

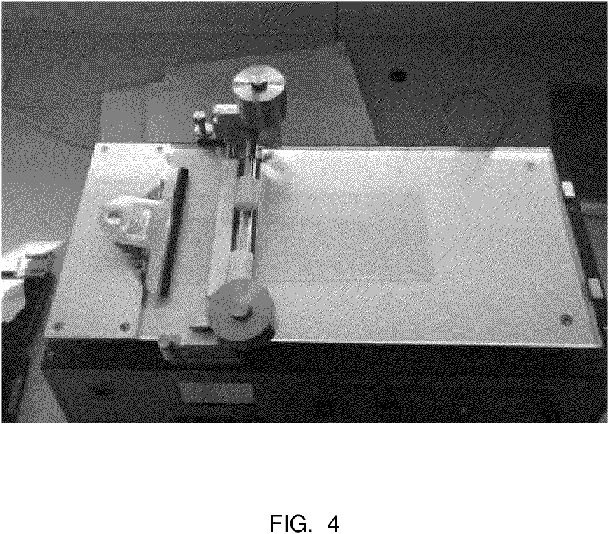

The coating composition was then applied on the surface, forming a layer of about 25 µm, using BIUGED and BGD219 instruments in a speed of 6 mm/sec, as shown in FIG. 4. Each coating composition was prepared a few hours, or about 24 hours prior to being applied on the surface.

### Example 2: Antimicrobial Activity Against Gram-Negative and Gram-Positive Bacteria

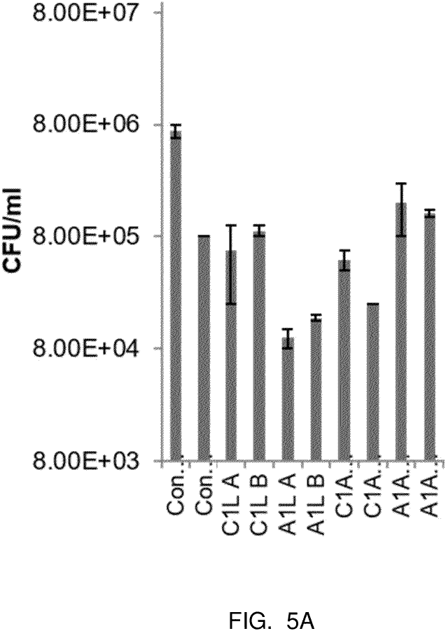

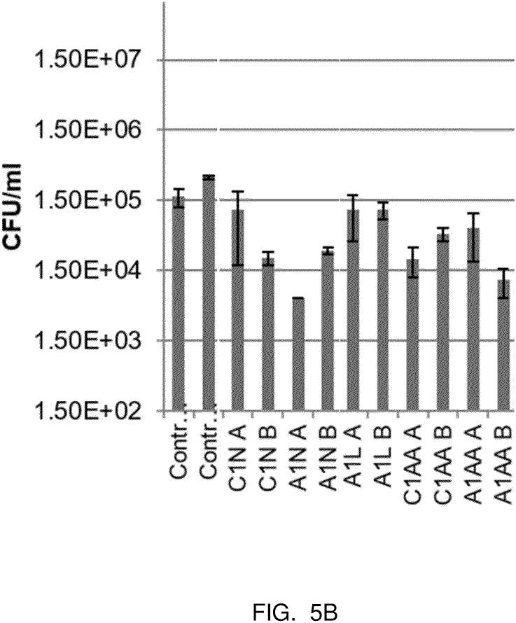

The antimicrobial activity of several coatings was tested against Gram-negative bacteria E. Coli and Gram-positive bacteria Listeria (FIGS. 5A and 5B, respectively, n=3 per each test). Each test was repeated twice (suffix A and B; in FIGS. 5A to 5B). Table 1 lists the coatings that were used in this example.

TABLE 1

antimicrobial coating

| Antimicrobial agent | Polymer | Concentrations | | Name (FIGS. 5A,B) |
|---|---|---|---|---|
| | | Polymer | Antimicrobial agent | |
| Lauryl alginate | Chitosan | 1% chitosan in 1% acetic acid (AcA) | 5 mg/ml | C1L |
| Lauryl alginate | Alginate | 1% Alginate in H₂O | 5 mg/ml | A1L |
| Ascorbic acid (AA) | Chitosan | 1% chitosan in 1% AcA | 5 mg/ml | C1AA |
| Acetic acid (AcA) | Alginate | 1% Alginate in H₂O | 5 mg/ml | A1A |
| Nisin | Chitosan | 1% chitosan in 1% AcA | 5 mg/ml | C1N |
| Nisin | Alginate | 1% Alginate in H₂O | 5 mg/ml | A1N |
| Ascorbic acid (AA) | Alginate | 1% Alginate in H₂O | 5 mg/ml | A1AA |

The viral count demonstrated in FIGS. 5A - 5B indicate that lauryl alginate and ascorbic acid are highly cytotoxic (reducing viral count by at least one order of magnitude, as measured in colony-forming units (CFU)) coating against Gram-negative and Gram-positive bacteria, irrespective of the polymeric matrix in which they are embedded. Nisin also exhibited high cytotoxicity against Gram positive bacteria, irrespective of the polymer (matrix) in which it is embedded.

### Example 3: Antimicrobial Activity Against Pseudominas Aeruginosa Alone and Pseudominas Aeruginosa Hosting Pf4 Phage

Surfaces were coated with the following coating materials: benzoic acid salt embedded within urethan acrylate matrix (ZP-1-70-B), and salicylic acid salt embedded within urethan acrylate matrix (ZP-1-70-S). Each coating material was applied in high concentration (HC; 3.0 weight percentage (3.0 wt%)), or low concentration (LC; 0.5 wt%). CuSO₄ is toxic and was used as positive control, where water (DDW) was used as negative control. Compositions comprising the tested bacteria, with or without (-) the Pf4 phage, were applied on the coated surfaces and the antimicrobial effected was evaluated by viral count.

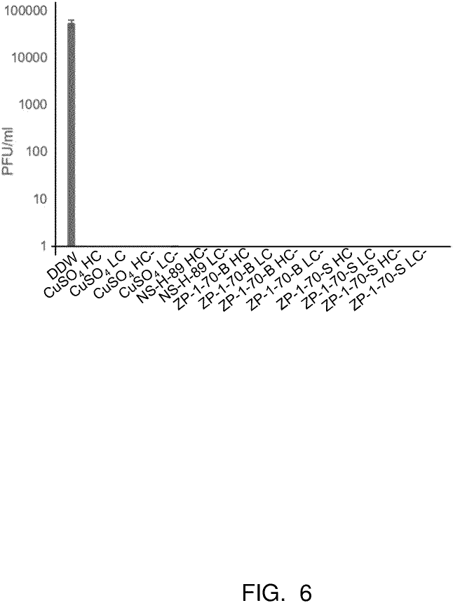

The viral count demonstrated in FIG. 6 indicates that all of the tested coatings, at high and low concentrations (HC and LC, respectively) exerted excellent antimicrobial effect against the tested bacteria as is, or hosting the Pf4 phage (-), compared to control (water; DDW) and similar to the reference toxin, CuSO₄. The activity of all tested surfaces caused complete toxic effect, as demonstrated by PFU (plaque forming units) = 0, while in the absence of the coating, the viral count exhibited PFU of about10⁶ (DDW column, FIG. 6).

### Example 4: Testing Antimicrobial Coating Containing Chitosan

The coating listed in Table 2 were tested. Testing include evaluation of particle size and distribution of chitosan in acidic solution, evaluation of the effect of neutralizing the acidity of the surface on the antimicrobial activity of the coating that contain chitosan and re-evaluation of antimicrobial activity of selected coatings having a thickness of about 100 µm when wet. Neutralizing acidity is aimed to obtain a stable pH, and hence a stable dispersion.

TABLE 2

Chitosan containing coatings

| Bacteria | Name | Antimicrobial agent | Matrices | Concentrations | |
|---|---|---|---|---|---|
| | | | | Polymer | Antimicrobial agent |
| - | Control | - | - | - | - |
| E. coli Listeria | C1 | Chitosan | Chitosan | 1% Chitosan in 1% ACA | - |
| E. coli Listeria | A1 | - | Alginate | 1% Alginate in H₂O | - |
| | | | | 50:50 v% blend of | |
| E. coli | AC1 | Chitosan | Chito/Alg | 1% chitosan in 1% AcA/ 1% Alginate in H₂O | - |
| Listeria | C1N | Nisin | Chitosan | 1% Chito in 1% AcA | 5 mg/ml |
| Listeria | A1N | Nisin | Alginate | 1% Alg in H₂O | 5 mg/ml |
| E. coli | A1L | Lauryl alginate | Alginate | 1% Alg in H₂O | 5 mg/ml |
| E. coli Listeria | ClAA | Ascorbic acid | Chitosan | 1% Chito in 1% AcA | 5 mg/ml |
| E. coli Listeria | A1AA | Ascorbic acid | Alginate | 1% Alginate in H₂O | 5 mg/ml |
| Listeria | PW1 | - | Pectin | 1% Pectin in H₂O | - |
| Listeria | PW1AA | Ascorbic acid | Pectin | 1% Pectin in H₂O | 5 mg/ml |
| E. coli Listeria | C1OH | Chitosan | Chitosan | 1% Chitosan in 1% AcA | Neutralization reaction with OH⁻ |

### Example 5: Thermal Stability of the Antimicrobial Coating

The antimicrobial effect was tested on polyethylene terephthalate (PET) sheets coated with antimicrobial composition. To this end, a water dispersion of urethane acrylate was used as the matrix, in which a derivative of salicylic acid salt was embedded, thereby forming the antimicrobial composition/coating. It is to be understood that it is always the salt of the corresponding acid that is used as the antibacterial agent embedded into the matrix. This coating was termed ZP 1-70S. Coating was performed as explained in Example 1 and shown in FIG. 4.

Next, the coated PET sheets were subjected to thermoforming (using the ‘one stop’ instrument of ILLIG Ltd). During thermoforming, the coated PET sheets were exposed to a temperature of about 140° C., for about 20 seconds, and immediately thereafter the coated sheets were shaped under vacuum to a desired shape. The shaped products looked well, the uniformity and stability of the coating was maintained and showed no sign of thermal damage.

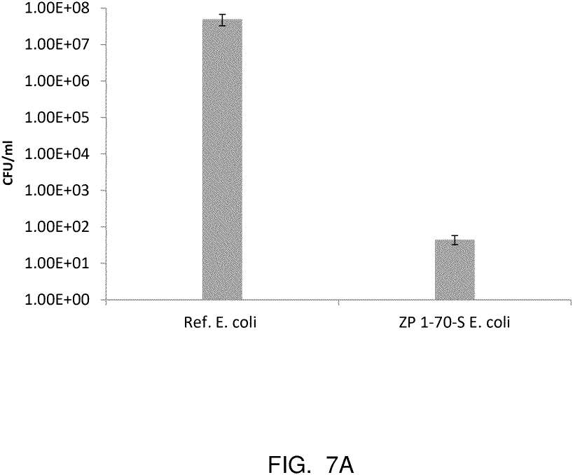

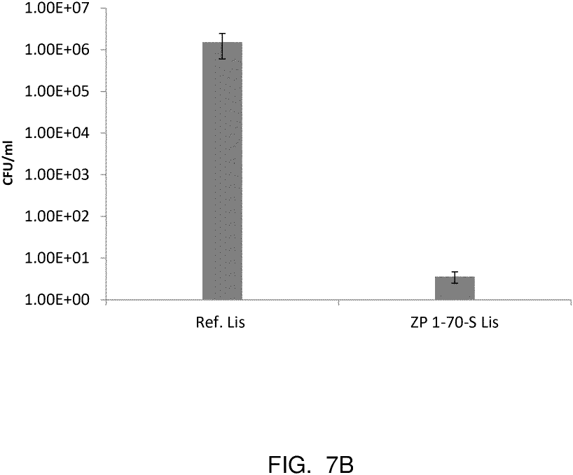

The antibacterial activity of the thermo-shaped coated PET products was tested in the presence of Gram-negative (E. Coli) and Gram-positive (Listera) bacteria, as shown in FIGS. 7A and 7B, respectively. The results clearly demonstrate that the thermoforming did not damage the antimicrobial activity of the coating by presenting reduction in CFU by over five (5) orders of magnitude compared to control (bacterial CFU on uncoated PET). Accordingly, the coating has a thermal stability, and the antimicrobial efficiency of the antimicrobial agents embedded within the matrix, to form the coating, is not impaired under heat.

### Example 6: Activity of Antimicrobial Composition Coating a Rigid Paperboard

The activity of seven (7) different antimicrobial coatings was tested against E-coli and S. aureus bacterial strains. The tested coating compositions (including a non-active formula, used as a negative control/reference), are listed in Tables 3 and 4, below. As detailed above, the coating composition was prepared by suspending solid antimicrobial agent in the polymer solution.

The antimicrobial activity of the coated surfaces was determined via the static biofilm formation assay. Bacteria were grown overnight in MH (Mueller Hinton) growth medium. Following one day of incubation, the bacteria were diluted with MH 1% to obtain a working solution with an OD595 of 0.3 and 0.01 for E. coli and S. aureus, respectively. The medium used for S. aureus was supplemented with 0.2% glucose. The stock bacterial solutions of each bacterial strain was incubated in a 24-well plate (DE-GROOT; 1 ml stock solution/well) and matrix (1 cm in diameter) was added to each well. Following incubation for 20 h at 37° C., the samples were rinsed three times with distilled water to remove the unattached bacteria (i.e. planktonic cells) and then the attached cells were scraped from the surface using 250 µl of MH 1% and cell scrapers (Greiner Bio-one). A fraction (200 µl out of the 250 µl) was transferred into a first line of a 96-well plate (Greiner Bio-One), while the rest of the wells/lines were filled with 180 µl of MH. Serial dilutions were carried out and the cells spotted onto LB agar plates, which were then incubated at 37° C. for 20 h. Cell growth was monitored and determined by a viable cell count. Each of the coating samples was laid on a paperboard substrate.

TABLE 3

Coating contents

| # | Sample Name | | Coating | Antimicrobial agent |
|---|---|---|---|---|
| 1 | P (ref.) | n=4 | P* (Pliodisp DV X56-529 - Polyvinyl Acetate water dispersion) | - |
| 2 | PAL | n=4 | P*/Alginate natural bio-polymer blend | Lauric alginate (LAE) |
| 3 | PCAA | n=4 | P*/Chitosan natural bio-polymer blend | Ascorbic acid (AA) |
| 4 | PAA | n=4 | P* | AA |
| 5 | PAZ | n=4 | P*/Alginate natural bio-polymer blend | Zinc oxide (ZnO) |
| 6 | PAZ2 | n=4 | # P*/Alginate natural bio-polymer blend | # ZnO |
| 7 | PZP | n=4 | P*/Adcote (ADCOTE 37 R 972 E (water-based EVA-copolymer resin dispersion)) blend | Sodium salt of salicylic acid (ZP-1-70-S) |

#: double coating

TABLE 4

Detailed information of each coating

| # | Polymer Matrix | | Antimicrobial agent | Concentrations | |
|---|---|---|---|---|---|
| | | | | Antimicrobial agent (solid) | Polymer (solution) |
| 1 | P* | - | - | - | - |
| 2 | P* | alginate | Lauric alginate | 5 mg/ml | 1% Alginate in H₂O |
| 3 | P* | chitosan | ascorbic acid | 5 mg/ml | 1% Chitosan in 1% ACA |
| 4 | P* | P* | ascorbic acid | 5%wt ascorbic acid of total dry material weight | - |
| 5 | P* | alginate | ZnO-suspension 40%s | 5% wt alginate of total dry material weight | 1% Alginate in H₂O |
| 6 | P* | #alginate | # ZnO-suspension 40%s | # 5% wt alginate of total dry material weight | |
| 7 | P* | Adcote | ZP-1-70-S | 1% wt Adcote of total dry material weight | - |

Acetic acid (ACA or AcA) is added to the polymeric solution of chitosan for creating acidic pH which is necessary for forming the chitosan suspension in water.

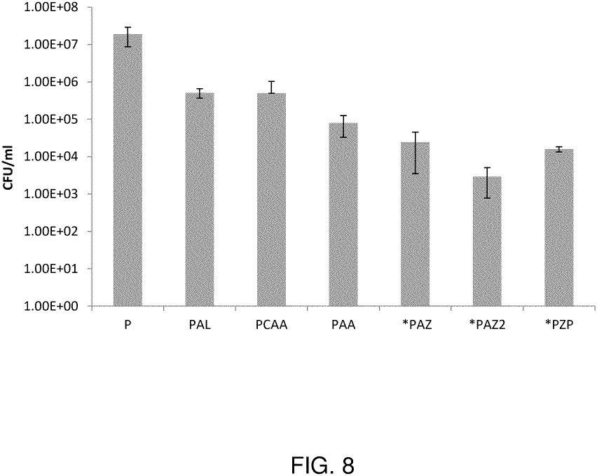

As shown in FIG. 8, all of the formulations used for coating paperboard showed statistically significant antimicrobial effect, namely, they all reduced viral count (measured by CFU) by at least one order of magnitude. The most effective coating was a composition comprising polyvinyl acetate water dispersion/Alginate and zinc oxide.

While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

In the description and claims of the application, the words “include” and “have”, and forms thereof, are not limited to members in a list with which the words may be associated.

Unless otherwise defined, all technical and scientific terms used herein have the same meaning as commonly understood by one of ordinary skill in the art to which this disclosure pertains. In case of conflict, the patent specification, including definitions, governs. As used herein, the indefinite articles “a” and “an” mean “at least one” or “one or more” unless the context clearly dictates otherwise.

1. A food packaging material comprising an outer surface and an inner surface, the inner surface is configured to face food product enclosed by the food packaging material, and a coating composition comprising a dispersion of:
at least one antimicrobial active agent; and
a hydrophilic polymer selected from the group consisting of: urethanes, urethane-acrylates wherein the contents of acrylate is less than 50%, ethylene-vinyl-acetates, alginate, acrylic-ester polymers, zein-protein polymers, and chitosan polymers,
wherein said at least one antimicrobial active agent is immobilized within the coating composition, and wherein the coating composition is configured to coat at least one of said inner and outer surfaces.

2. The food packaging material according to claim 1, wherein the at least one antimicrobial agent is selected from the group consisting of: essential oils, acids, esters or salts thereof and bacteriocins.

3. The food packaging material according to claim 1, wherein said coating composition is coating said inner surface.

4. (canceled)

5. (canceled)

6. The food packaging material according to claim 1, wherein said coating composition is forming a film coating said inner and/or outer surfaces.

7. The food packaging material according to claim 1, wherein said food product comprises fresh food product.

8. The food packaging according to claim 7, wherein the fresh food product comprises any one or more of fluid, semi-fluid and solid food product.

9. The food packaging material according to claim 1, wherein said coating composition is configured to perform antimicrobial activity only upon contacting a surface of the fresh food product.

10. (canceled)

11. The food packaging material according to claim 1, comprising a rigid scaffold comprising the outer surface and the inner surface .

12. The food packaging material according to claim 1, being a polymeric packaging material.

13. (canceled)

14. (canceled)

15. The food packaging material according to claim 1, wherein the hydrophilic polymer is formed of a food grade polymer.

16. The food packaging material according to claim 11, wherein the rigid scaffold comprises any one or more of wood, paper and paperboard-based material.

17. The food packaging material according to claim 1, being a polymeric food packaging.

18. The food packaging material according to claim 17, being transparent.

19. A container configured to contain the food product therewithin formed from the food packaging material of claim 11.

20. (canceled)

21. (canceled)

22. A coating composition for food packaging, the coating composition comprising a dispersion of at least one antimicrobial active agent and a hydrophilic polymer selected from the group consisting of: urethanes, urethane-acrylates wherein the contents of acrylate is less than 50%, ethylene-vinyl-acetates, alginate, acrylic-ester polymers, zein-protein polymers, and chitosan polymers, wherein said at least one active agent is immobilized within the coating composition.

23. The coating composition according to claim 22, wherein the at least one active agent is selected from the group consisting of: chitosan, nisin, benzoic acid salt, salicylic acid salt, ascorbic acid, zinc oxide and lauric arginate.

24. The coating composition according to claim 22, configured to exert antimicrobial activity only upon contacting a humid surface of food product or a skin of a subject.

25. A method for coating a surface of a food packaging material, the method comprising:
providing a food packaging material comprising an inner surface and an outer surface;
applying to at least one surface of the food packaging material a hydrophilic thermoplastic polymer dispersion comprising at least one antimicrobial active agent, wherein the hydrophilic thermoplastic polymer is selected from the group consisting of: urethanes, urethane-acrylates wherein the contents of acrylate is less than 50%, ethylene-vinyl-acetates, alginate, acrylic-ester polymers, zein-protein polymers, and chitosan polymers; and
dry-curing the applied polymer dispersion, thereby coating said at least one surface such that the at least one active agent is immobilized within the coating.

26. The food packaging material according to claim 1, wherein the at least one antimicrobial agent is selected from the group consisting of: chitosan, nisin, benzoic acid salt, salicylic acid salt, ascorbic acid, zinc oxide and lauric arginate.

27. The method according to claim 25, wherein the at least one antimicrobial agent is selected from the group consisting of: chitosan, nisin, benzoic acid salt, salicylic acid salt, ascorbic acid, zinc oxide and lauric arginate.
